(19) United States
(12) Patent Application Publication
(10) Pub. No.: US 2005/0033457 A1
(43) Pub. Date: Feb. 10, 2005

(54) Simulation aid tools and ladder program verification systems

(76) Inventor: Hitoshi Yamane, Tokyo (JP)

Correspondence Address: BEYER WEAVER & THOMAS LLP, P.O. BOX 778, BERKELEY, CA, 94704-0778, US

(21) Appl. No.: 10/898,686

(22) Filed: Jul. 23, 2004

(30) Foreign Application Priority Data
Jul. 25, 2003 (JP) 2003-280506

(51) Int. Cl. G05B 11/01

(52) U.S. Cl. 700/18

(57) ABSTRACT

A simulation aid tool uses a variable extracting part to analyze a ladder program to be tested and extracts variables used in the ladder program. A test input sequence managing part manages a test input sequence describing a table that correlates command, variable name and normal input value of each of input variables in the extracted variables in the order of test input. A test input ladder generating part generates a test input ladder program according to the test input sequence created by the test input sequence managing part. A ladder program verification system includes, connected by a network, a virtual I/O which is a programmable controller for generating virtual I/O having the test input ladder program generated by such a simulation aid tool installed and a programmable controller for executing a test target program which is a ladder program to be tested. The virtual I/O executes the test input ladder program to obtain test input signals and sequentially transmits the test input signals to the programmable controller through the network. The programmable controller obtains the test input signals and executes the test target program based on the obtained test input signals.

Priority is claimed on Japanese Patent Application 2003-280506 filed Jul. 25, 2003.

### BACKGROUND OF THE INVENTION

This invention relates to simulation aid tools and ladder program verification systems, as well as program products.

Programmable logic controllers (PLC) are commonly used as a control device in factory automation. Such a PLC is usually comprised of a plurality of units of various kinds combined appropriately together such as a CPU unit for carrying out calculations according to a control program, an input unit connected to input devices such as sensors and switches for receiving their on/off signals therefrom as input signals, an output unit connected to output devices such as actuators and relays for transmitting output signals thereto, a communication unit connected to a host apparatus or the like for exchanging data therewith and a power source unit for supplying power to these units. The PLC thus structured is adapted to cyclically repeat processes such as taking input signals inputted through the input unit into the I/O memory of the CPU (the so-called IN-refresh process), performing logical calculations on the basis of a control program which is created by using the preliminarily registered ladder language (the calculation process), transmitting the results of such a calculation process to the output unit by writing them in the I/O memory (the OUT-refresh process), and thereafter making communications with a host apparatus or a display device connected to the network (the so-called peripheral service processes).

Prior to the start of an actual operation, however, it is necessary to carry out a preliminary verification process in order to ascertain whether the control program will operate correctly. Such preliminary verifications are usually carried out without actually using the equipment, the control program being tested as a desk research such that the number of adjustment steps to be actually carried out at the site (such as program corrections and editing) can be reduced. According to one of the currently carried out test methods, an input signal is provided from a simulator device to a PLC incorporating the control program to be verified. Such a simulator device may be adapted to generate a test input signal for the PLC and to have it inputted to the PLC but a separate program (written, say, in the ladder language) for generating an input signal for the test is necessary for the simulator device to have inputted to the PLC. In the past, such a program for generating a test input signal was created manually. Recently, however, attempts are being made for improvements in order to reduce the manpower required for the creation of such a program. Japanese Patent Publication Tokkai 10-133717, for example, disclosed a method according to which several basic ladder circuits are preliminarily prepared according to a representative pattern of the inspection test and stored in a memory. A scenario means is provided to arbitrarily select one of these several basic circuits and its prosecution sequence and the contents of input/output data are manually set such that a ladder program can be automatically created by reading out a necessary ladder circuit from the memory by the scenario means. The labor for creating a ladder program for simulation can be somewhat reduced by such a method.

By prior art methods of preliminary verification, however, the ladder program for test input was created manually and hence a programmer with a skill in ladder programming was required. In particular when a complicated test is required, a high level of skill is frequently required. Especially where the ladder program to be tested has a large number of input interfaces, the ladder program for test input may become enormous and it becomes cumbersome to create such a program for test input, requiring an increased number of preparatory work steps. By a method of using preliminarily stored basic ladder circuits to create a ladder program for simulation, on the other hand, only tests within a limited range can be carried out and those tests not intended by the basic ladder circuits cannot be carried out. If any test outside the intended range is desired, it becomes necessary to create a new program manually.

Moreover, prior art methods could only ascertain whether or not the control program would correctly function when input signals were correctly inputted in a correct sequence but were incapable of checking the operations when an input signal different from a normal signal was inputted. Since they cannot stop the program execution being carried out on the PLC, furthermore, the test cannot be interrupted in its midst and hence the result of any instantaneous result change could not be ascertained.

### SUMMARY OF THE INVENTION

It is therefore an object of this invention to provide a simulation aid tool, a ladder program verification system and a program product capable of automatically creating a ladder program for test input by automatically extracting variables for test input from the target control program to be tested.

A simulation aid tool according to this invention may be characterized as comprising a variable extracting part for analyzing a ladder program to be tested and extracting variables, including input variables, used in this ladder program, a test input sequence managing part for managing a test input sequence describing a table that correlates command, variable name and normal input value of each of the input variables in the extracted variables in the order of test input, and a test input ladder generating part for generating a test input ladder program according to the test input sequence created by the test input sequence managing part.

According to this invention, a test input sequence is created by arranging input variables in the order in which they are executed and a test input ladder program is automatically generated according to this test input sequence. In other words, the test input sequence is arranged in the order of test input and is in the form of a table that correlates normal values, etc. of each of the input variables. Thus, a ladder program for these input variables can be created by placing junction points having the normal values of these input variables as the input condition. Since they are listed in the order of input, a test input ladder program for outputting input signals can be easily created by arranging these ladder circuits in the order of input.

Thus, since the test input ladder can be created without being conscious of ladders, even a mechanical designers without the knowledge of ladder can carry out tests of a high level. Since variables to be inputted can be easily picked up even from a long and complicated ladder, the number of test design steps can be reduced. If the logic for checking the result is buried on the test input ladder, furthermore, even an instantaneous change in the result can be made detectable.

In addition to the above, there may be further provided a variable managing part for storing the variables extracted by the variable extracting part by classifying into input variables and output variables and storing the input variables in correlation with values that can be assumed as test input values and a test input pattern managing part for referencing the test input values stored in the variable managing part and creating and managing a test input data pattern including an abnormal pattern having an abnormal value which is not a normal value set as a test input value of a specified input variable in test input sequence such that the test input ladder generating part is adapted to generate the test input ladder program based on the abnormal pattern. If a test input ladder program can thus be created on the basis of an abnormal pattern, it becomes possible to check the operations not only under normal conditions but also at the time of occurrence of an abnormal situation. It becomes possible also to automatically create a ladder program for continuously carrying out a plurality of test cases such as abnormal cases and this makes it possible to conduct unmanned tests.

The ladder program contains a plurality of programs (component programs) structured in units of modules. The aforementioned test input sequence managing part creates a test input sequence in units of these modules for each of the programs and may preferably be provided with a module test sequence importing part for importing the test input sequences thus created thereby in units of modules to a test input sequence of the whole ladder program so as to be synthesized. This embodiment is preferable because the test input sequences created in units of modules can be utilized when the test input sequence for the entire control program is created.

A ladder program verification system according to this invention may be characterized as having a network connecting a virtual I/O (which is a programmable controller for generating virtual I/O having installed therein the test input ladder program created by the simulation aid tool of this invention as described above) and a programmable controller (hereinafter “the programmable controller”) for executing a test target program (which is a ladder program to be tested) and wherein the virtual I/O is adapted to execute the test input ladder program to obtain test input signals and to sequentially transmit the test input signals to the programmable controller through the network, and the programmable controller is adapted to obtain the test input signals and to execute the test target program based on the obtained test input signals. With a ladder program verification system thus structured, a ladder program can be preliminarily verified by using an automatically created test input ladder program for a test input such that time control can be effected and the same test can also be repeated easily.

The ladder program verification system may be further so structured that the simulation aid tool and the virtual I/O are network-connected, that the simulation aid tool is adapted to download the generated test input ladder program to the network-connected virtual I/O, and that the virtual I/O is adapted to execute the downloaded test input ladder program and to output the test input signal. In the above, the network that connects the simulation aid tool and the virtual I/O and the network that connects this virtual I/O and the programmable controller which executes the test target control program may be the same or different. If they are the same, the simulation aid tool will also be able to upload the test target control program from the programmable controller.

A program product according to this invention may be characterized as comprising a first program part for carrying out a first process of analyzing a test target ladder program and thereby extracting variables that are used in the ladder program, a second program part for carrying out a second process of managing a test input sequence describing a table that correlates command, variable name and normal input value of each of input variables in the extracted variables in the order of test input, and a third program part for carrying out a third process of generating a test input ladder program according to the test input sequence created in the second program part.

In summary, variables for test input are automatically extracted from a control ladder program such that a test input ladder program is automatically generated. Thus, even a user such as a mechanical designer without any knowledge of ladder can carry out a test of a high level.

### BRIEF DESCRIPTION OF THE DRAWINGS

FIG. 1 is a block diagram of an example of ladder program verification system embodying this invention.

FIG. 2 is a block diagram of a simulation aid tool according to this invention.

FIG. 3 is an example of total system control ladder program.

FIG. 4 is an example of data structure managed by the variable managing part.

FIGS. 5A and 5B, together referred to as FIG. 5, are a particular example of total system control ladder program.

FIG. 6 is a flowchart for the operations of the I/O variable extracting part.

FIG. 7 shows an example of test input sequence for clamp 1 module.

FIG. 8 is an example of test pattern with an abnormality pattern included.

FIG. 9 is a flowchart showing the functions of the input data pattern managing part.

FIG. 10 shows the operations of the input data pattern managing part.

FIG. 11 shows an example of total system ladder test sequence.

FIG. 12 is a flowchart showing the functions of the module test sequence importing part.

FIG. 13 shows an example of total system ladder test sequence.

FIG. 14, comprising FIGS. 14A and 14B, shows an example of test sequence of another program called by CALL command, FIG. 14A showing an initialization sequence called by the first CALL command in the total system ladder test sequence of FIG. 13 and FIG. 14B showing an abnormal sequence called by the second CALL command.

FIG. 15 is a flowchart of the virtual input ladder generating part.

FIG. 16 is a flowchart showing the algorithm of Step ST 32 of FIG. 15.

FIGS. 17A and 17B are examples of ladder circuit corresponding to IN command.

FIG. 18 is a flowchart showing the algorithm of Step ST 33 of FIG. 15.

FIGS. 19 and 20 are examples of ladder circuit corresponding to CHECK command.

FIG. 21 is a flowchart showing the algorithm of Step ST 34 of FIG. 15.

FIG. 22 is an example of ladder circuit corresponding to CALL command.

FIG. 23 is an example of ladder circuit shifting one pattern being executed to a next pattern.

### DETAILED DESCRIPTION OF THE INVENTION

The invention is described by way of an embodiment for carrying out a preliminary verification of a control program incorporated in a PLC which is the target of a test where there is no sensor or other input devices present or under a condition where the factory automation system as a whole is not functioning and no input signal is being provided from any of the input devices even if they are present.

In order to carry out this verification, an input signal must be provided to the target PLC at a specified timing. According to the present embodiment, this input signal for the verification is generated by another PLC (which is hereinafter also referred to as the “PLC for generating virtual I/O” or merely the “virtual I/O”). This PLC and the target PLC are connected by a network so as to allow communications therebetween and the input signal is generated by causing a verification program (the “virtual input ladder program”) to be executed by this PLC for generating virtual I/O and is communicated to the target PLC. The verification program is preliminarily created and downloaded to the PLC for generating virtual I/O. The test is carried out as the PLC for generating virtual I/O provides the generated input signal to the target PLC at a specified timing and the target PLC executes the control program to be tested on the basis of the received input signal. Verification whether the operation is carried out normally or not and debugging are carried out on the basis of this result.

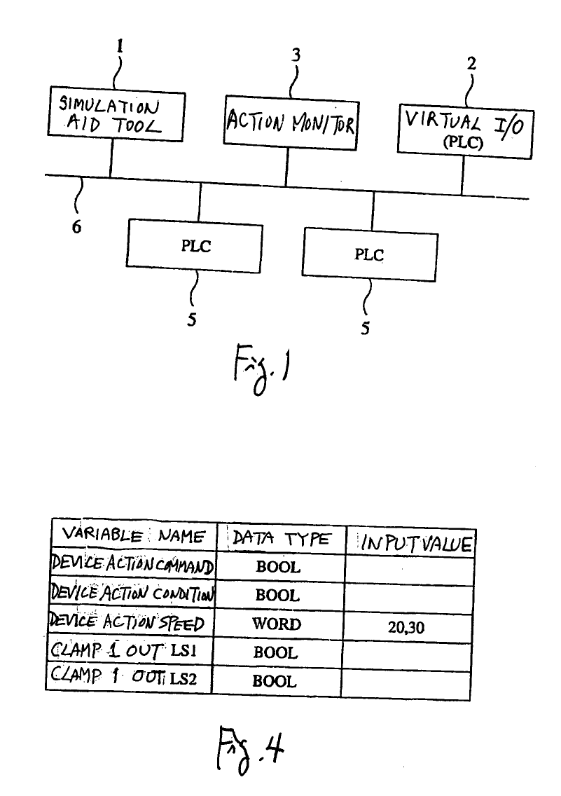

FIG. 1 shows a factory automation system embodying this invention which may be set in a production factory, having a specified number of PLCs 5. If a plural number of PLCs are present, they are connected together by a control network 6 and the operations proceed with the PLCs 5 synchronized and/or cooperating among them. In an actual system, each of these PLCs may be connected directly or indirectly to an output device of various types or a robot to be controlled or to an input device such as a sensor or a switch but they may not necessarily be connected to such an input or output device when a verification of a downloaded control program is carried out and at least no signal is provided from an input device.

Some of the control programs mounted to the PLCs 5 may comprise function blocks. A function block is comprised of input and output parameters, internal data and a program code and is written with a quadrangular body part at the center, an input part on the right-hand side of the body part and an output part on the left-hand side of the body part. The body part is a program for a block of actions and is created separately by the ladder language.

According to this invention, a simulation aid tool 1 for generating a virtual input ladder program for providing verification input signals to the target PLCs 5 to be tested, a PLC for generating virtual I/O (the “virtual I/O PLC”) 2 for outputting a test input signal at a specified timing by executing a virtual input ladder program created by this simulation aid tool 1, an action monitor 3 for monitoring the conditions of the target PLCs 5 during the operation test or the test results and the target PLCs 5 for testing are all connected to the same network. Thus, the simulation aid tool 1 functions to create a virtual input ladder program on the basis, for example, of the target control program to be verified mounted to the target PLC to be tested and to download the created program through the network 6 to the PLC 2 which is to become the virtual I/O generating simulator (the “virtual I/O”). The virtual I/O PLC 2 executes the downloaded virtual input ladder program to thereby output the input signals through the network 6 to the target PLCs 5 to be tested at a specified timing.

As the target PLCs 5 to be tested receive the input signal from the virtual I/O PTC 2 at the specified timing, they carry out the control program sequentially. The conditions during the execution of the test program and the result of the execution can be monitored by the action monitor 3. In other words, the action monitor 3 can collect and display the data stored in the IO memories of the target PLCs 5 to be tested and thereby check their operations. Alternatively, a 3D simulator may be separately activated within the action monitor 3 so as to have the action of a robot or the like controlled by the PLCs 5 displayed on the image screen on the action monitor 3 as in a virtual space based on the collected data such that its motion can be checked.

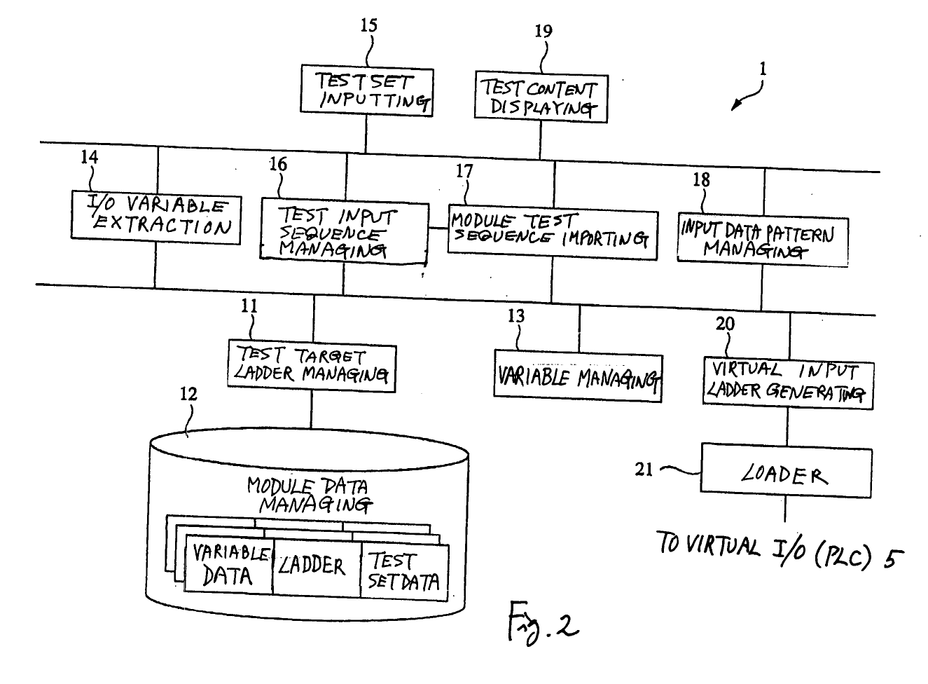

The simulation aid tool 1 for creating a virtual input ladder program may be realized by installing an application program with specified functions in a personal computer. Such a personal computer may have other tools with different functions also installed. Its structure may be as shown in FIG. 2.

In FIG. 2, numeral 11 indicates a test target ladder managing part for managing a control program (say, a program written in the ladder language) for the target to be tested. In the above, “managing” means to obtain a ladder program installed in a target PLC 5 to be tested by uploading and to record and store it in a specified memory device, as well as to read out a ladder program which has been recorded and stored and to transmit it to another processing part. If a programming tool having the functions of creating and editing a control program (ladder program) is installed in the personal computer forming the simulation aid tool 1 and the target ladder program to be tested has been created by such a programming tool installed in the same personal computer, the test target ladder managing part may be adapted to manage also such test target ladder programs created and stored within the same personal computer.

In the case of a control program composed of a plurality of component module programs, module data are managed for each of the component module programs by a module data managing part 12. The module data include a list of input-output variables for the module (“variable data”), a module ladder program (“ladder”) and test sequence and test pattern data set at the time of the testing (“test set data”). The module data managed by this module data managing part 12 are also obtained by uploading from the PLC 5, as done by the test target ladder managing part 11. The module data managed by the module data managing part 12 may be transmitted to another processing part when called by the test target ladder managing part 11.

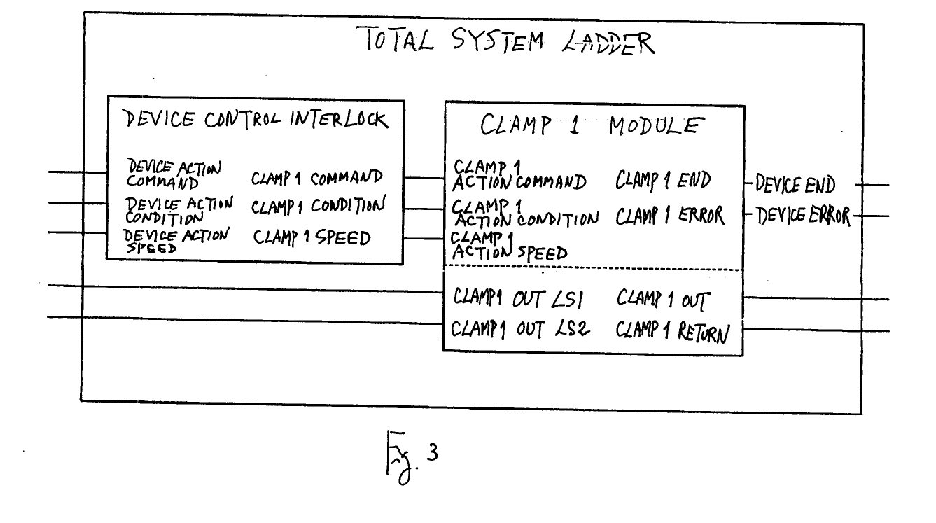

Variables defined in the test target program are managed by a variable managing part 13. Input variables, output variables and inner variables are separately managed within the range of test target. For the convenience of explanation, let us assume that a total system control program as shown in FIG. 3 is being managed by the module data managing part 12. This program is formed as a combination of “clamp 1 module” and “device control interlock”, and is assumed to serve as the test target program. Each module is written with function blocks. “Clamp 1 action command”, “Clamp 1 action condition” and “Clamp 1 action speed”, which are input I/F of “clamp 1 module” are treated as inner variables from the “device control interlock” module and are not input variables of the total system control program.

When both the action command and the action condition are switched on, the total system control program outputs a clamp action signal (out/return) and, after the action, it is completed at the timing when the end LS (limit switch) is switched on. As the whole system, the action of clamp 1 is started when both a device action command and a device action condition are switched on and the action is completed when the action of clamp 1 is completed.

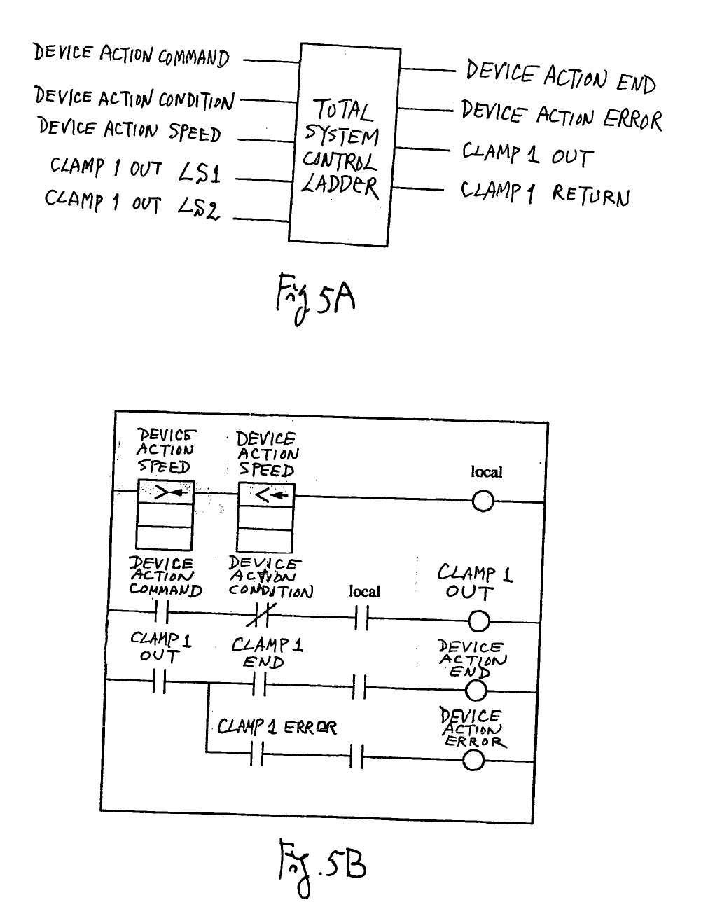

The variable managing part 13 classifies all variables defined in the test target program into input variables and output variables within the test target range. A list with the structure of a table as shown in FIG. 4 is created in the case of a control program as shown in FIG. 3 and is managed by the variable managing part 13. For the input I/F variables, the user selects a variable name, a data type and a value which may be taken as the test input value for the purpose of automatic creation of test pattern, to be explained below. FIG. 4 shows an example where input values of 20 and 30 are selected as device action speed. Boolean variables (BOOL) need not be set because they can be either TRUE of FALSE.

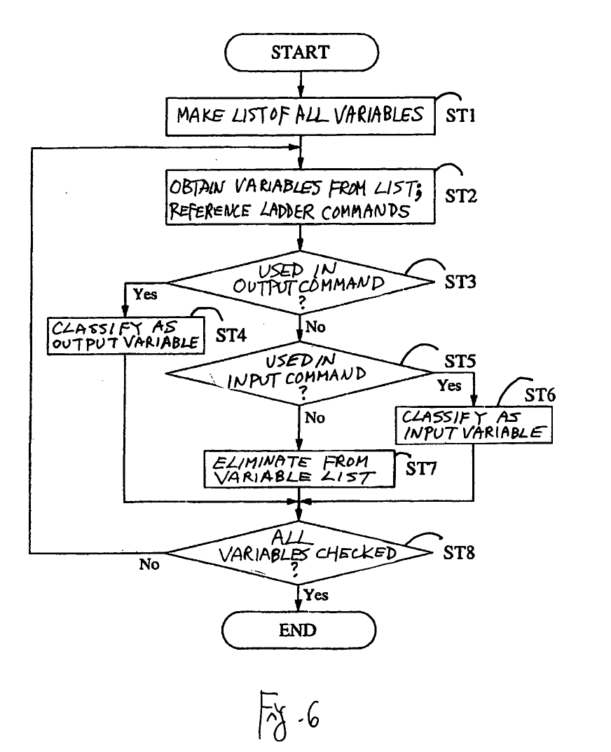

Of the variable data managed by the variable managing part 13, the variable names and the data types are extracted by an I/O variable extraction part 14. In other words, it is this I/O variable extraction part 14 that serves to obtain the test target ladder program through the test target ladder managing part 11 and to extract the input variables by analyzing its contents. Explained more in detail, the ladder program is scanned for all variables defined by the test target ladder and those used as output variables are classified as an output variable and those not used as such are classified as an input variable. For example, if the total system control ladder is as shown in FIG. 5A, its actual ladder program is as shown in FIG. 5B. Thus, variable names such as device action speed and device action command can be extracted therefrom. Since “clamp 1 out” is used in the OUT command, it is classified as an output variable and since “device action command” is not used in the output command, it is classified as an input variable.

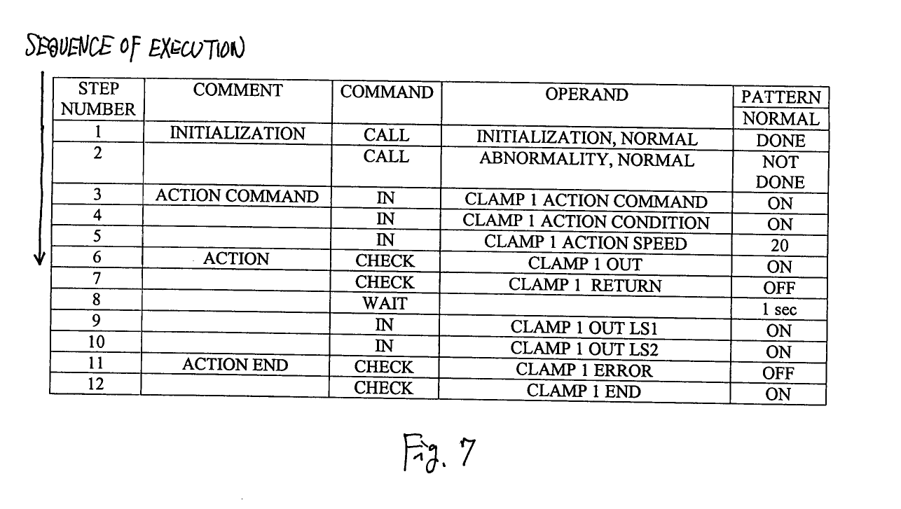

The operations of the I/O variable extraction part 14 are carried out as shown by the flowchart of FIG. 6. To start, a search is made over the target ladder program to be tested to make a list of all variables used therein (Step ST1), Next, a variable name is selected one at a time sequentially from the beginning of the created list and the ladder commands using variables with the variable name are referenced (Step ST2). This is done by obtaining the test target ladder program (module data) from the test target ladder managing part 11 and extracting every part where a variable with the selected variable name is used in that ladder program.

For each extracted part, it is then determined whether it is used in an output command (Step ST3) and it is classified as an output variable (Step ST4) if it is used as an output command (YES in Step ST3). If it is not used as an output command (NO in Step ST3), it is determined whether it is used in an input command (Step ST5). If it is found to be used in an input command (YES in Step ST5), it is classified as an input variable (ST6) because this means that it is being used only in an input command. If it is not being used either in an output command or in an input command (NO in Step ST5), it is eliminated from the variable list (Step ST7).

The routine described above is repeated until all variable names have been classified (YES in Step ST8).

Of the data managed by the variable managing part 13, the input values to be taken by input variables other than the Boolean variables are inputted by a test set inputting part 15 adapted to receive test set data inputted by the user. If the user operates a mouse to make an input, it is transmitted to the variable managing part 13 as the test input value so as to be stored therein in correlation with the corresponding variable name.

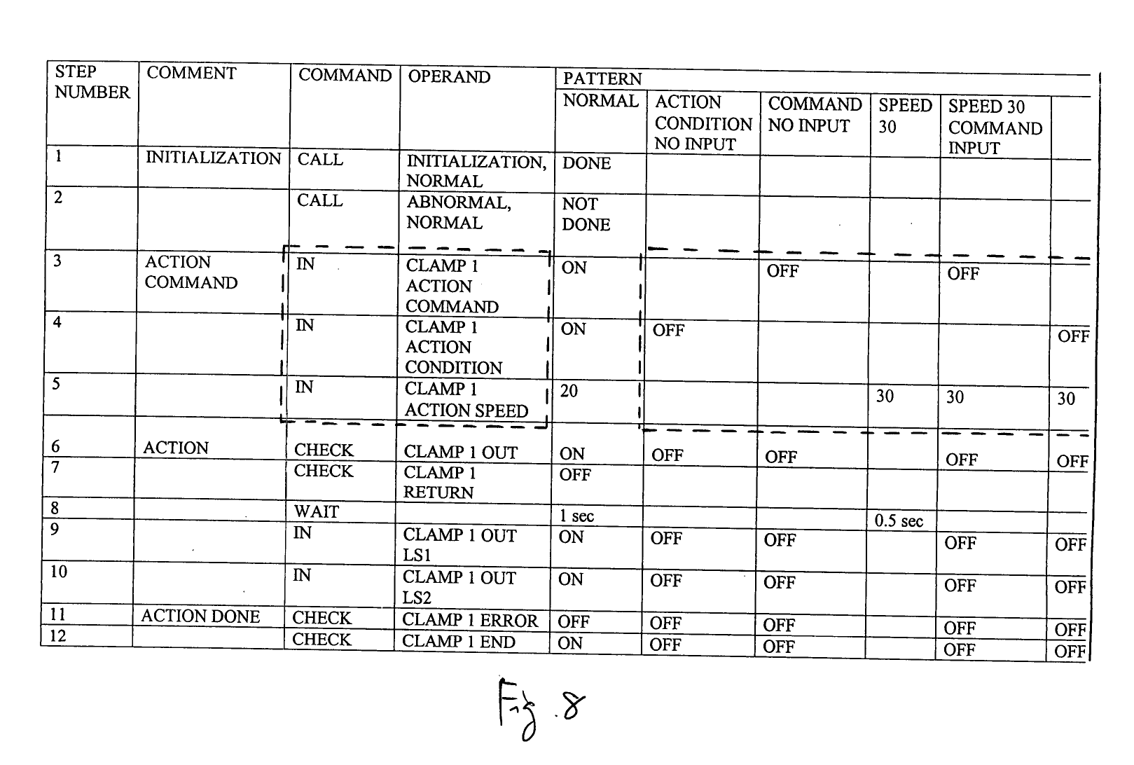

The test set sequence indicative of the test input sequence of the input variables defined by the user is managed by a test input sequence managing part 16 adapted to obtain the input variables extracted by the I/O variable extraction part 14, to reference the sequence of their execution in the target ladder program to be tested and to create a test input sequence as shown in FIG. 7 according to this execution sequence. FIG. 7 is an example of set test input sequence for clamp 1 module which is one of the modules.

The test input sequence and the test result check timing for the test input are described by using a script language. In other words, the sequence commands and operands of IN, CHECK and CALL are described. The operand of the IN command is an input variable, and this command is for inputting data to the input variable. Since the variable selection can be made from the input variable list, a selection which is easy and not likely to cause an error can be made. The operand of the CHECK command is an output variable and this command is for checking a change in the output variable against input data. Since the variable selection can be made from the output variable list, a selection which is easy and not likely to cause an error can be made. The operand of the CALL command is a sequence name and this command is for calling a test sequence which is separately defined. A test sequence may be made into a structure by means of this command. Although FIG. 7 shows a test sequence wherein a normal value of the test input value for each input variable is managed in correlation, the normal pattern made up of such normal test input values is inputted manually by the user. In other words, the test set inputting part 15 transfers such input from the user to the test input sequence managing part 16, creates a test sequence correlating the normal pattern obtained there and stores it for managing it.

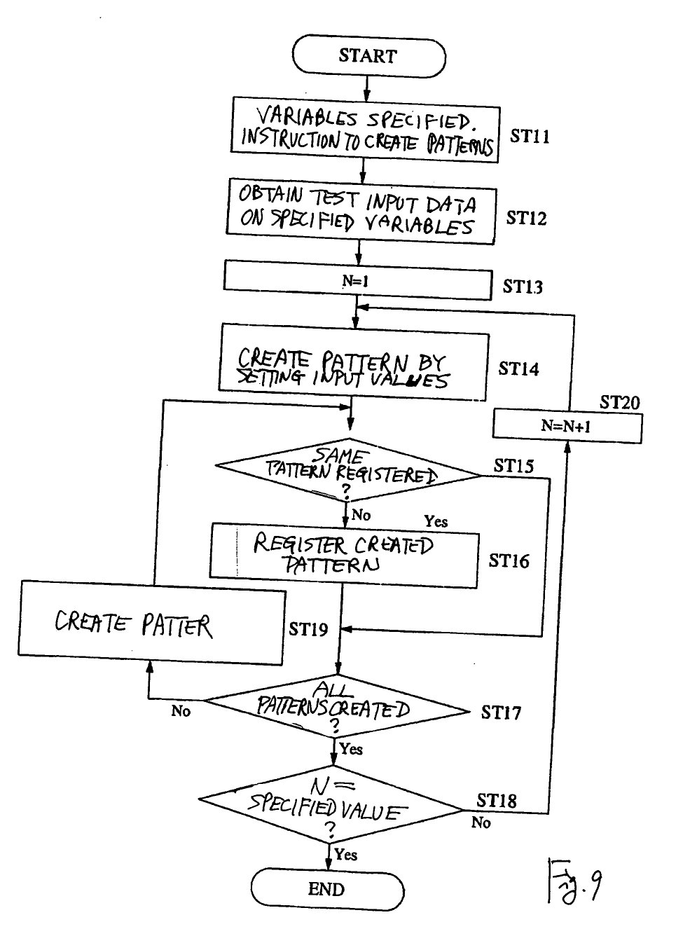

The input data pattern managing part 18 has the function of creating test input values for an abnormal pattern based on a test sequence with a normal pattern as shown in FIG. 7 and adding them to a test pattern. By this function, a test pattern such as shown in FIG. 8 can be created and not only actions of a test target ladder program operating normally but also actions in a condition where an abnormal situation has appeared can be checked. In the test pattern of FIG. 8, the blanks indicate that the same value as that of the normal pattern on the left-hand end is taken. Although not shown, another abnormal pattern is also added on the right-hand side of the test pattern.

It is by such functions, for example, that the variables described in a sequence are outputted for a display and the user selects a list of variables with which it is desired to create a combination pattern. FIG. 8 shows an example wherein “clamp 1 action command”, “clamp 1 action condition” and “clamp 1 action speed” are specified. After such a combination of data values of selected variables is automatically created, a new row is added as pattern data. In summary, test input data of selected variables are obtained from the variable managing part 13, an allowed input value is taken in the case of a variable of other than the Boolean type, normal and abnormal values are identified for each of the variables and a pattern is created as a combination of input values such that at least one of the variables is abnormal if a plurality of variables have been specified.

The input data pattern managing part 18 functions as shown in the flowchart of FIG. 9. To start, the program waits for the user to specify variables from the test sequence through the test set inputting part 15 and when such specification is received, an instruction is made to create a pattern (Step ST11). This is done, for example, by displaying a test sequence as shown in FIG. 7 on the monitor screen through a test content displaying part 19 and having a pointing device such as a mouse to be operated on the display screen so as to indicate variables for creating a pattern combination. The process described above is carried out by obtaining specified variable names.

Next, test input data on specified variables are obtained from the variable managing part 13 (Step ST12). In the case of a variable of an other-than Boolean data type, all data on input values that can be taken (20 and 30 in the case of Device action speed in the example of FIG. 4) are obtained. In the case of a variable of the Boolean data type, since it can take only the value of TRUE or FALSE, it may be obtained as such or the test input value may not be obtained if there is no particular test input value by merely causing it to be judged as the Boolean type.

Next, the number N of the variables of which the value is to be changed from the default value is set equal to 1 (Step ST13). A pattern is formed by changing the input value from the default value (that is, the value set in the normal pattern) for N of the specified group of variables (Step ST14). The pattern thus created is registered in the input data pattern managing part 18 (Step ST16), which serves to manage test input patterns for variables described in test input sequences, if another identical pattern is not already registered (NO in Step ST15). If there is another identical pattern already registered (YES in Step ST15), the program does not do anything. In this manner, an abnormal pattern with at least one variable with an input value which is not normal is created.

It is then examined whether or not all patterns combining N variables different from the default values have been created (Step ST17). If they have not (NO in Step ST17), a new pattern (that is, another pattern with the input values of N variables other than those changed in Step ST14 set at values different from the default values) is created (Step ST19) and the program returns to Step ST15. If this pattern is not registered yet (NO in Step ST15), it is registered in the input data pattern managing part 18.

If ail patterns have been created (YES in Step ST17), if the value of the dummy index N at this moment agrees with the number of variables for which creation of pattern has been specified (Step ST18). If they agree (YES in Step ST18), the program is ended because this means that all abnormal patterns have been created. If they do not agree (NO in Step ST18), the value of the dummy index N is incremented by 1 (Step ST20) and Step ST14 and the steps thereafter are repeated with the incremented value of N. In this manner, all abnormal patterns having only one of the specified variables is set to a value different from the default value are created, all abnormal patterns having any two of the specified variables are set to values different from the default values are created, etc. such that the number of variables to have values set differently from the default values is increased by 1 each time, until an abnormal pattern with all specified variables taking a value different from the default value is created such that all abnormal patterns that are to be created can be created.

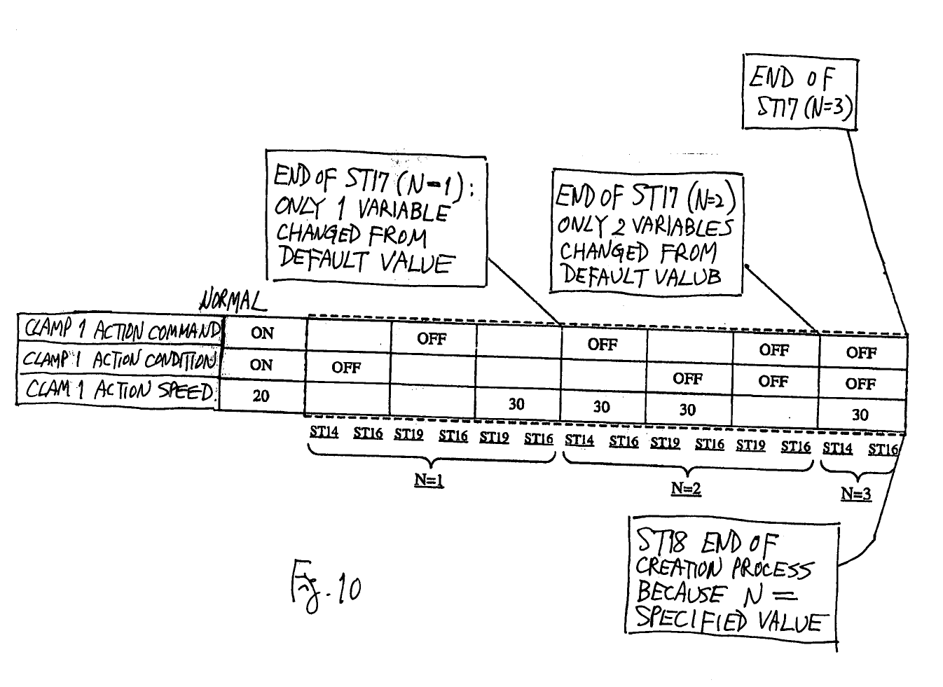

Consider the sequences shown in FIG. 8, for example. Let us assume that a command to create a pattern has been received regarding the three variables “clamp 1 action command”, “clamp 1 command action condition” and “clamp 1 action speed”. This means that the number of specified variables is 3. Since N is set equal to 1 in Step ST13, three abnormal patterns with one of the three specified variables set at a value different from the default value in Step ST14 or ST19 are created as shown in FIG. 10 and they are registered in Step ST16.

Next, since N is set equal to 2 (Step ST20), Steps ST14 and ST19 are carried out with this new value of N such that abnormal patterns with two of the specified three variables set to a value different from the default value are created and registered.

Thereafter, N is set equal to 3 and Step ST14 is carried out with N set equal to 3, creating an abnormal pattern with all three specified variables set to a value different from the default value. Since the judgments in Steps ST17 and ST18 become YES in this situation, the process for creating abnormal patterns is now ended. In all, seven abnormal patterns are thus created by the input data pattern managing part 18.

According to the embodiment of the invention described in FIG. 2, there is also provided a module test data importing part 17 for importing test data of constituent modules into a test sequence currently being set. Although it was explained above that the test input sequence managing part 16 serves to create test patterns by creating test sequences in units of modules, it is not sufficient to merely verify the program in units of modules and it is necessary to eventually verify that the control program as a whole, inclusive of all these modules, can function correctly. The module test data importing part 17 is therefore adapted such that the sequences set at the time of the module test can be thereby used again also at the time of the overall system test.

For this purpose, the user specifies a range for importation from the module test sequence, thereby indicating the position where the total system sequence currently being set should be imported, and outputs a request to import. In response, the variable managing part 13 checks whether the variable written in the operand of the IN command of the module test sequence is an input variable or an inner variable in the total system ladder. After this checking is done, the IN command having the variable made into an inner variable is replaced in CHECK command.

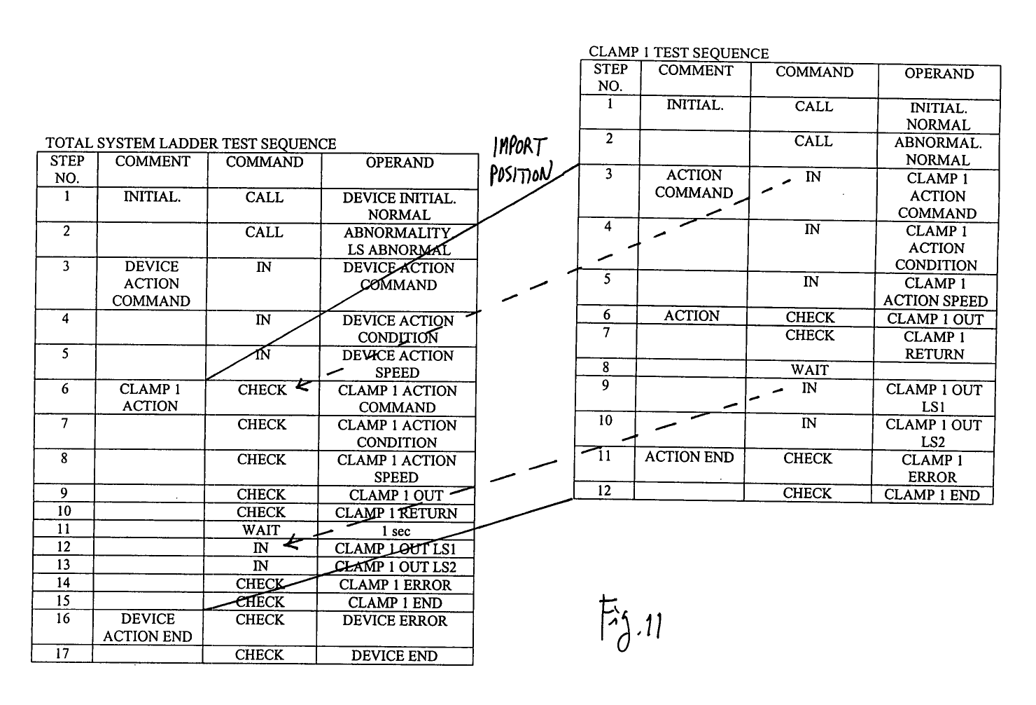

If it is desired to reuse a test sequence for “clamp 1 module” when the total system ladder test sequence shown in FIG. 11 is being created, for example, “clamp 1 action command” firstly replaces IN command by CHECK command because it is an inner variable in the total system ladder but “clamp 1 output S1” remains as it is because it is an input variable also in the total system ladder.

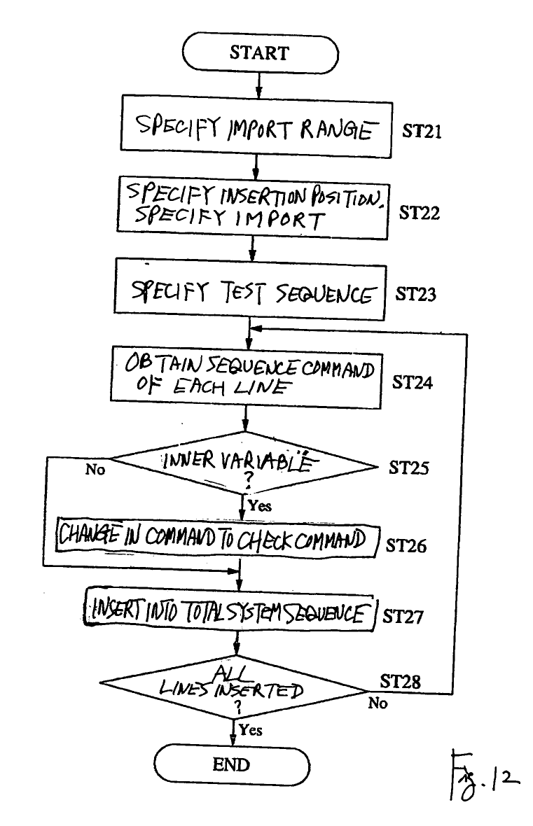

FIG. 12 is a flowchart that shows the process described above. The user starts by obtaining through the test set inputting part 15 a range to be imported specified from the module test sequence (Step ST21). In the example of FIG. 11, “clamp 1 test sequence” is displayed on the displayer and the range to be imported (step numbers 3 through 12) may be indicated on the screen by a pointing device or by text-inputting the starting step number (“3” in the example) and the end step number (“12” in the example).

Next, the destination position of the total system test sequence specified by the user is obtained (Step ST22). In the example of FIG. 11, step numbers after “5” in the total system ladder are specified as destination positions. This indication may also be effected by displaying the test sequence and by using a pointing device to directly indicate the destination of importation or by inputting step numbers.

Next, the test sequence data in the specified range of the test set data corresponding to the module specified from the module data managing part 12 are read out (Step ST23) such that the sequence commands on each line of the module test sequence data which have been read out are obtained (Step ST24).

It is then examined whether or not the sequence command defined in the obtained line is IN command and the described variable is an inner variable in the total system ladder (Step ST25). If these conditions are satisfied (YES in Step ST25), IN command is changed into CHECK command (Step ST26) and it is inserted into the total system sequence (Step ST27). If the described variable is not an inner variable (NO in Step ST25), the line which has been read out is inserted into the total system sequence (Step ST27).

It is then examined whether or not all of the lines within the specified range have been inserted (Step ST28). If there is a line which has not been inserted (NO Step ST28), the program returns to Step ST24 to carry out the next cycle of steps on the next line. By thus repeating Steps ST24 to ST28, all sequence lines within the specified importation range can be inserted into the desired positions in the total system sequence.

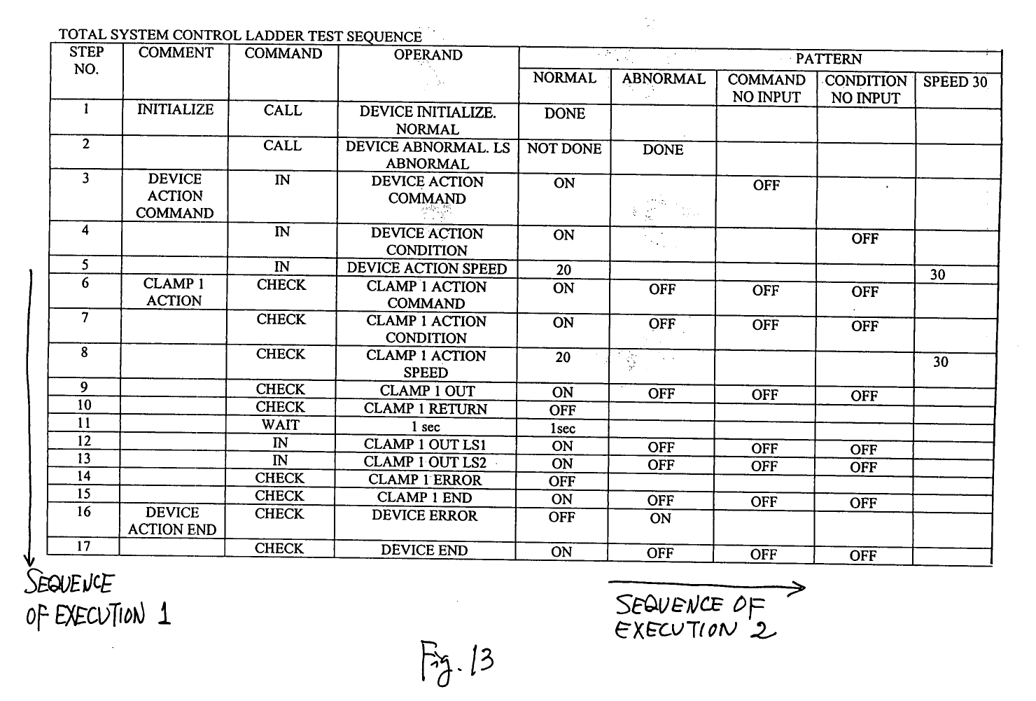

Final test data as shown in FIGS. 13 and 14 are thus created also for a test sequence (total system ladder test sequence) for a total control program with an imported module test sequence by creating test patterns including normal and abnormal patterns by means of the test input sequence managing part 16 and the input data pattern managing part 18. FIG. 13 shows a total system ladder test sequence and FIG. 14 shows a sequence of another program called by CALL command within this total system ladder test sequence shown in FIG. 13. In FIG. 14, FIG. 14A shows an initialization sequence called by the first CALL command (Step No. 1) in the total system ladder test sequence and FIG. 14B shows an abnormal sequence called by the second CALL command (Step No. 2). The last test data include a test input sequence which defines the order for executing the processes of each command and input data patterns (normal and abnormal patterns) for defining the input values provided at the time of executing the sequence. The test input sequence (inclusive of normal patterns) is managed by the test input sequence managing part 16, while the abnormal patterns in the input data pattern are managed by the input data pattern managing part 18. It may be so arranged that the normal patterns are also managed by the input data pattern managing part 18 or that all data are joined together to be managed (stored) in the form of final test data as shown in the figure.

The final test data (with input data patterns (normal and abnormal patterns) added to test input sequence) shown in FIGS. 13 and 14 are transmitted to a virtual input ladder generating part 20 where a virtual input ladder is created. In other words, a virtual input ladder is created by the virtual input ladder generating part 20, corresponding to each command in the test sequence and, as the processing of each command is completed, a ladder is created such that a ladder corresponding to the next command will be executed. The order for executing the commands is arranged such that each pattern is executed sequentially from Step No. 1. In other words, steps for normal patterns of the first pattern (Pattern 1) are carried out sequentially from Step No. 1 until Step No. 17 is reached. Next, abnormal patterns of the second pattern (Pattern 2) defined during occurrence of abnormality are carried out sequentially from Step No. 1 to Step No. 17. Next, the abnormal pattern of the third pattern (Pattern 3) defined regarding command no-input is carried out sequentially from Step No. 1 to Step No. 17. Similar steps are carried out thereafter repeatedly.

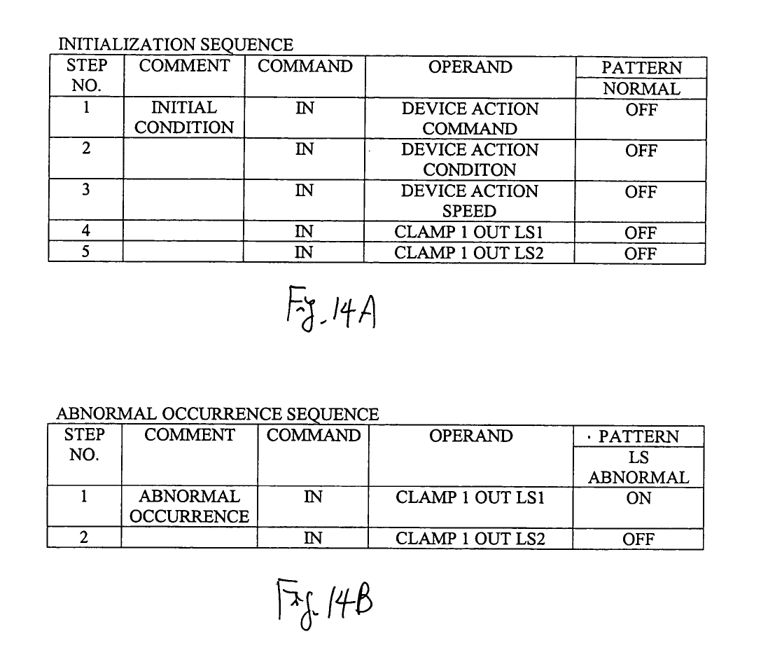

The function of the virtual input ladder generating part is explained next with reference to the flowcharts shown in FIG. 15 and thereafter. As shown in FIG. 15, test sequence data are first obtained from the test input sequence managing part 16 (Step ST31). Next, the IN command in the command column in the obtained test sequence data is referenced to create a ladder corresponding to the IN command (Step ST32). Next, CHECK command is referenced to create a ladder corresponding to the CHECK command (Step ST33) and CALL command is similarly referenced to create a ladder corresponding to the CALL command (Step ST34). A virtual input ladder is created thereafter by carrying out each process step to arrange the created ladders sequentially (Step ST35).

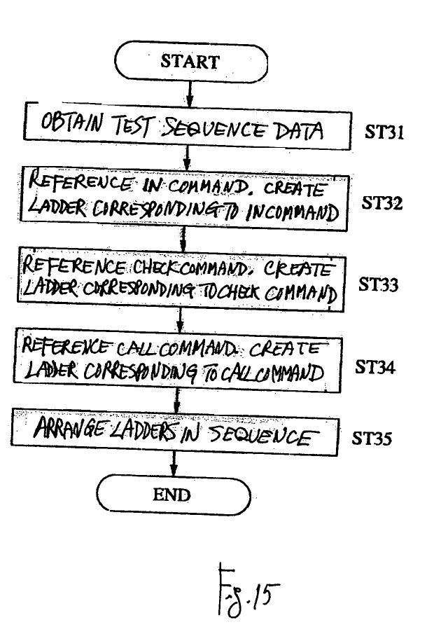

Next, each processing part is explained to describe the process for creating the ladders. The ladder corresponding to the IN command in Step ST21 is created by executing the flowchart shown in FIG. 16. This is done firstly by searching for an IN command from the first line in the sequence (Step ST41) and then judging whether or not an IN command has been detected (Step ST42). The result of this judgment becomes NO if no IN command is detected until the final line is reached. In other words, the search is started from the first line and the program proceeds to Step ST42 either until an IN command is detected or until the final line has been reached.

If an IN command has been detected (YES in Step ST42), another IN command with an identical operand is searched for (Step ST43). In other words, a step for switching the same variable on or off is searched for.

Regarding all of the IN commands referenced in Steps ST41 and ST43, corresponding pattern values are obtained from the input data pattern managing part 18 to check whether there are inputs of changes OFF→ON and ON→OFF (Step ST44). If there is an input of change OFF→ON (YES in Step ST45), the ON-part of a self-hold circuit is created on the basis thereof (Step ST46). If there is an input of change ON→OFF (YES in Step ST47) the OFF-part of the self-hold circuit is created on the basis thereof (Step ST 48). A self-hold circuit corresponding to an input variable is completed by combining the ON-part and the OFF-part thus created in Steps ST46 and ST48 (Step ST49). Next, it is determined whether or not there is an IN command in the steps subsequent to the detection in Step ST41 (or Step ST50 in the previous cycle after the second time) (Step ST50). If such an IN command is found to be present (YES in Step ST42), a self-hold circuit is created by executing the processes after Step ST43. The steps described above are repeated to a ladder circuit is created corresponding to all of the IN commands.

Next, the process of creating a self-holding circuit described above will be explained for “clamp 1 out LS1” of Step No. 12 and “clamp 1 out LS2” of Step No. 13 as examples.

For each pattern, the timing for the switch OFF→ON is detected and the pattern number and the sequence step number are grouped together with the AND-condition. The timing for the switch ON→OFF is similarly detected for each pattern and the B junction point of the pattern number and the B junction point of the step number are grouped together with the AND-condition. Thereafter, the circuits corresponding to the OFF→ON timing grouped for all patterns are grouped together with an OR-condition and the circuits corresponding to the OFF→ON timing are grouped together with an AND-condition to create an input ladder corresponding to one input variable.

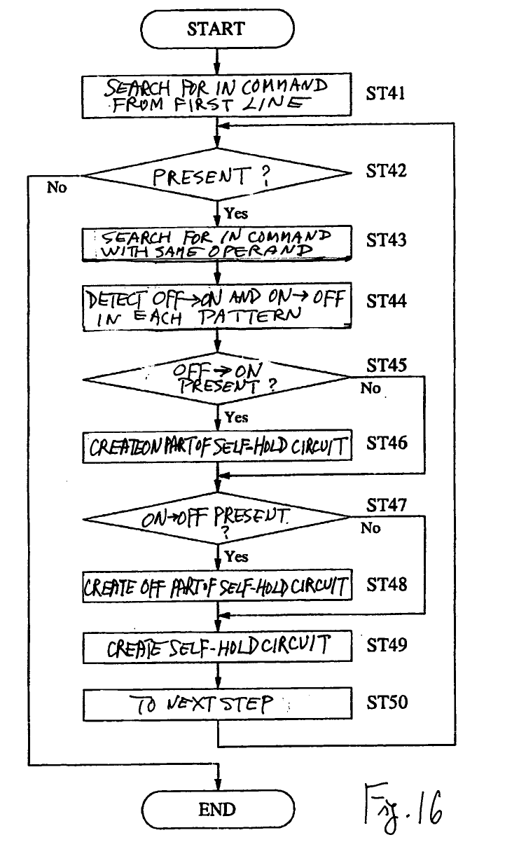

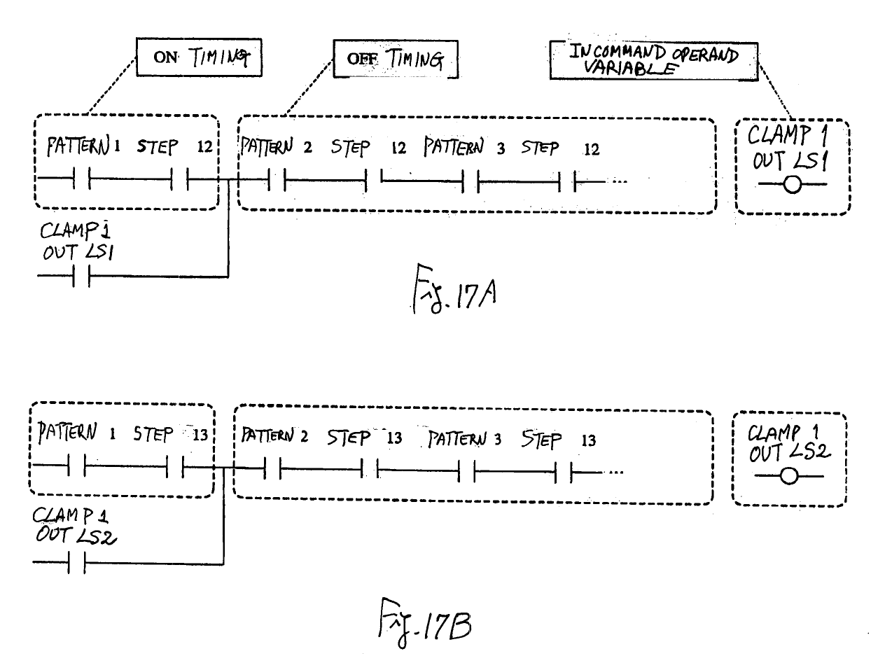

In the case of “clamp 1 out LS1”, for example, since it is switched from OFF to ON at Step No. 12 of the normal pattern, pattern 1 and step number 12 are connected in series (AND) to form a ladder circuit which becomes the ON-part of the self-hold circuit. Since it is switched from ON to OFF at step number 12 of Pattern 2 (during occurrence of abnormality), step number 12 of Pattern 3 (command no-input), etc., an AND connection is formed with the B-junction points of the corresponding pattern numbers and step numbers. In this manner, a self-hold circuit as shown in FIG. 17A is created for variable “clamp 1 out LS1”. Similarly, a self-hold circuit as shown in FIG. 17B is created for variable “clamp 1 out LS2”.

The ladder corresponding to the CHECK command of Step ST33 is created by carrying out the flowchart shown in FIG. 18. Since the process based on the IN command of Step ST32 is already carried out, a CHECK command is searched for from the first line of the sequence corresponding to the test sequence data obtained from the test input sequence managing part 16 when this process was executed (Step ST51) and it is judged whether or not a CHECK command has been detected (Step ST52). This judgment is NO if no CHECK command is found until the final line has been reached. In other words, the search is made sequentially from the first line and the process proceeds to Step ST52 either if a CHECK command has been detected or the final line has been reached.

If a CHECK command is present (YES in Step ST52), a corresponding check value is obtained from the input data pattern managing part 18 and the A junctions or the B junctions are combined corresponding to the check values with an OR-condition (Step ST53). Junction points corresponding to the step numbers are added with an AND condition to complete a check circuit (Step ST54). Thereafter, the CHECK command is searched for in the subsequent steps (Step ST55). This is done by determining whether a CHECK command is present or not in the subsequent steps since the detection in Step ST51 (or the previous Step ST55 at the second or later time). If the CHECK command is present (YES in Step ST52), the processes thereafter are repeated.

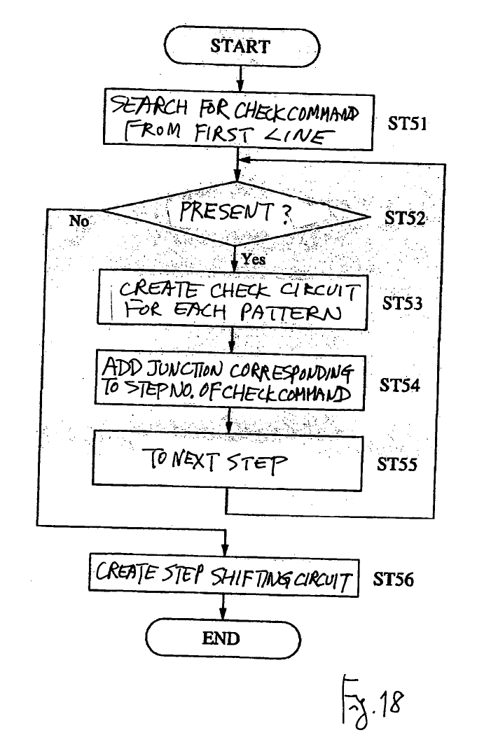

After all CHECK commands have been referenced (NO in Step ST52), a step shifting circuit is created (Step ST56) and this series of processing is completed. A virtual input ladder as shown in FIG. 19 may be created, for example, corresponding to “clamp 1 action command” of Step No. 6.

In the step where the CHECK command is described, it is checked whether the operand has been changed to its value. If the CHECK value is ON for each pattern, the pattern number and the variable to be checked are grouped together with an AND-condition (Pattern 1 & clamp action command) and if the CHECK value is OFF, the pattern number and the B junction point of the variable to be checked are grouped together with an AND-condition (Pattern 2 & clamp action command and Pattern 3 & clamp action command). Thereafter, the grouped circuits of all patterns are grouped together with an OR-condition and the step numbers where a CHECK command is described are added with an AND-condition.

When the CHECK condition in this ladder is satisfied, a flag indicative that a step is in execution, outputted from the ladder, is switched off and this process is completed.

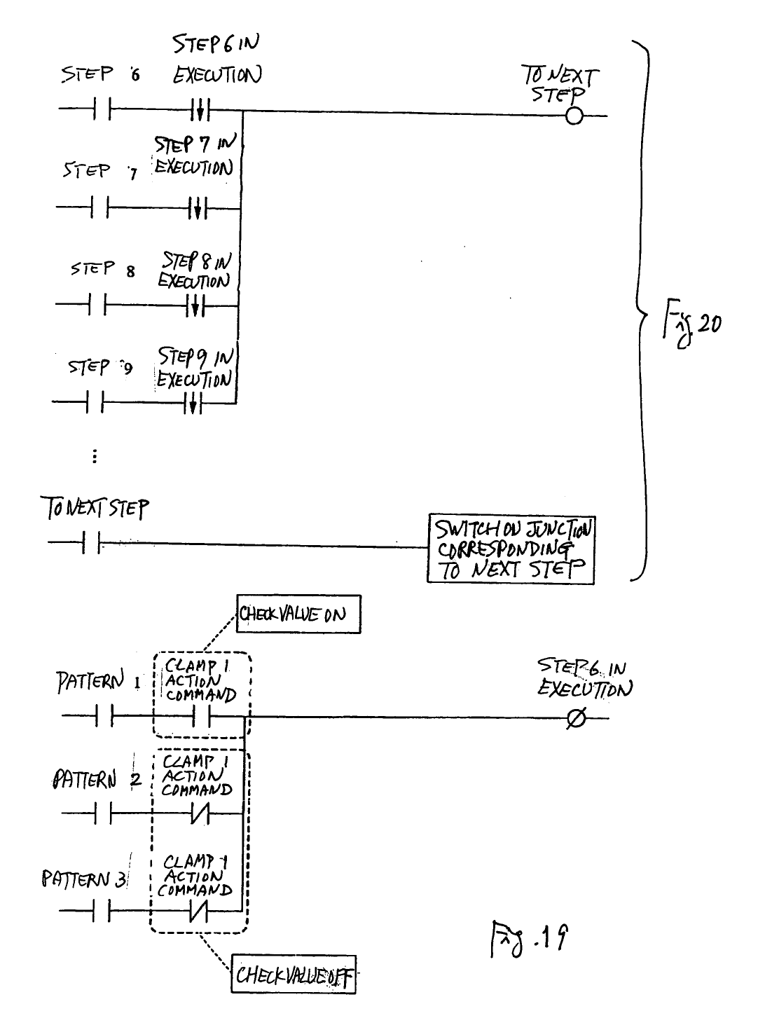

The IN command proceeds unconditionally to the next step but the CHECK command proceeds to the next step only when the CHECK condition is satisfied. In other words, the shift takes place at the timing when the coil is switched off while the step describing the CHECK command is being executed. This may be realized by a ladder circuit as shown in FIG. 20.

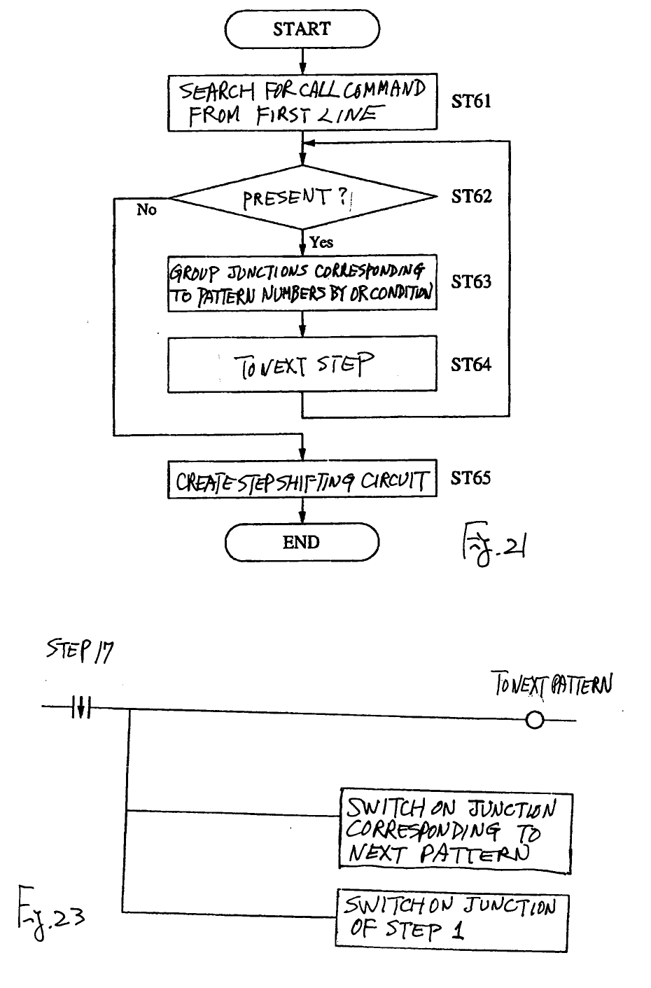

The process of ladder creation corresponding to the CALL command in Step ST34 may be carried out according to the flowchart of FIG. 21. Since the processes based on the IN command of Step ST32 are already carried out, a search is made for CALL commands from the first line of the sequence on the test sequence data obtained from the test input sequence managing part 16 at the time of executing such processes (Step ST61).

If a Call command is present, an execution/non-execution value is obtained from the input data pattern managing part 18 and junction points corresponding to the pattern set for execution are grouped together with an OR-condition (Steps ST62 and ST63). In the subsequent steps, thereafter, the CALL command is referenced (Step ST64), that is, it is checked whether a CALL command is present or not in steps after Step ST64. If a CALL command is present (YES in Step ST62), the processes in and after Step ST63 are carried out.

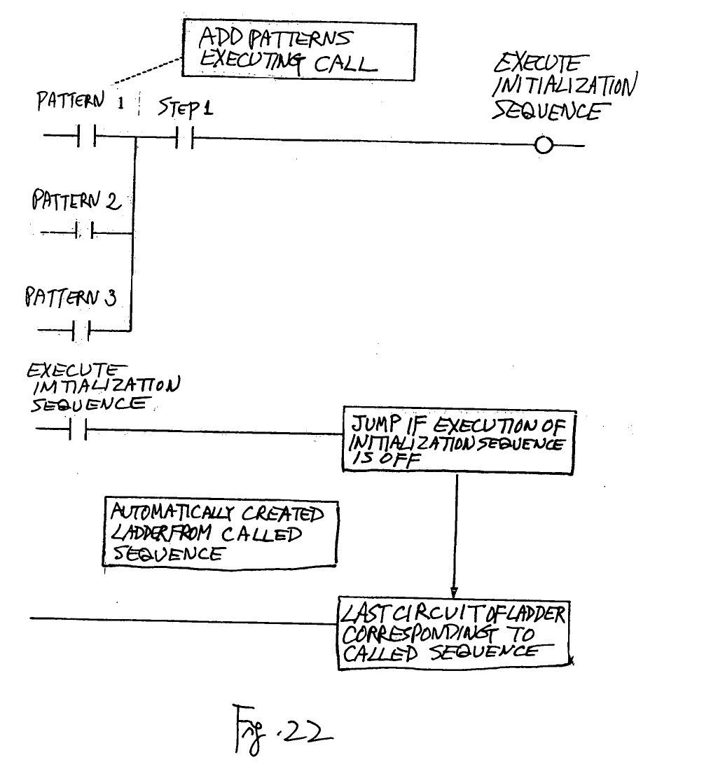

If no CALL command is found although the final line has been reached (NO in Step ST62), a step-shifting circuit is created (Step ST65) and this series of processing is concluded. As this series of processing is carried out, a ladder circuit as shown in FIG. 22 may be created for the initialization sequence from the test sequence shown in FIG. 13.

A pattern for executing the CALL may be added by an OR-condition in order to stop until the start flag of the sequence to be called and the sequence execution end flag of the sequence to be called are switched on. As is clear from FIG. 13, this is carried out in Step No. 1 of all patterns. Thus, the junction points of Pattern 1, Pattern 2, Pattern 3, etc. are connected by an OR-condition and the junction of Step No. 1 to each Pattern is connected by an AND-condition. Although the illustrated example shows only up to Pattern 3, the junction points of all patterns are connected by OR-connection.

When the junction point for the execution of initialization sequence is switched on, the virtual input ladder circuits created on the basis of the called initialization sequence are sequentially executed. When the last of the circuits is executed (when the execution end flag of the called sequence is switched on), the execution of this step is considered completed. Although not shown graphically, a virtual input ladder program can be created by the virtual input ladder generating part 20 also on the basis of the called initialization sequence shown in FIG. 14A.

Shifting to the next pattern is carried out after the last line of the present pattern is carried out. Since the execution of the next pattern is started from the first step number, a ladder program that checks whether the execution has been concluded to the last of the defined steps (Step No. 17) and then shifts the pattern to be executed to the next pattern is created. For example, a circuit as shown in FIG. 23 is created.

The virtual input ladder program thus created by the virtual input ladder generating part 20 is downloaded to the virtual I/O 2 through the network 6 by means of a loader 21.

Although an example has been shown wherein a virtual input ladder program is created based on a normal pattern and an abnormal pattern, this is not intended to limit the scope of the invention. It is sufficient if the virtual input ladder program is created at least based on a normal pattern.

1. A simulation aid tool comprising:
a variable extracting part for analyzing a ladder program to be tested and extracting variables used in said ladder program, said variables including input variables;
a test input sequence managing part for managing a test input sequence describing a table that correlates command, variable name and normal input value of each of said input variables in said extracted variables in the order of test input; and
a test input ladder generating part for generating a test input ladder program according to said test input sequence created by said test input sequence managing part.

2. The simulation aid tool of claim 1 further comprising:
a variable managing part for storing said variables extracted by said variable extracting part by classifying into input variables and output variables and storing said input variables in correlation with values that can be assumed as test input values; and
a test input pattern managing part for referencing said test input values stored in said variable managing part and creating and managing a test input data pattern including an abnormal pattern having an abnormal value which is not a normal value set as a test input value of a specified input variable in said test input sequence;
wherein said test input ladder generating part is adapted to generate said test input ladder program based on said abnormal pattern.

3. The simulation aid tool of claim 1 wherein said ladder program includes a program formed in units of modules; said simulation air tool further comprising a module test sequence importing part for importing test input sequences created by said test input sequence managing part to a test input sequence of the whole of said ladder program.

4. The simulation aid tool of claim 2 wherein said ladder program includes a program formed in units of modules; said simulation air tool further comprising a module test sequence importing part for importing test input sequences created by said test input sequence managing part to a test input sequence of the whole of said ladder program.

5. A ladder program verification system comprising:
a simulation aid tool including a variable extracting part for analyzing a ladder program to be tested and extracting variables used in said ladder program, said variables including input variables, a test input sequence managing part for managing a test input sequence describing a table that correlates command, variable name and normal input value of each of said input variables in said extracted variables in the order of test input, and a test input ladder generating part for generating a test input ladder program according to said test input sequence created by said test input sequence managing part;
a virtual I/O which is a programmable controller for generating virtual I/O having installed therein said test input ladder program generated by said simulation aid tool; and
a programmable controller for executing a test target program which is a ladder program to be tested, said programmable controller and said virtual I/O being connected through a network;
wherein said virtual I/O is adapted to execute said test input ladder program to obtain test input signals and to sequentially transmit said test input signals to said programmable controller through said network; and
wherein said programmable controller is adapted to obtain said test input signals and to execute said test target program based on said obtained test input signals.

6. The ladder program verification system of claim 5 wherein said simulation aid tool further comprises:
a variable managing part for storing said variables extracted by said variable extracting part by classifying into input variables and output variables and storing said input variables in correlation with values that can be assumed as test input values; and
a test input pattern managing part for referencing said test input values stored in said variable managing part and creating and managing a test input data pattern including an abnormal pattern having an abnormal value which is not a normal value set as a test input value of a specified input variable in said test input sequence;
wherein said test input ladder generating part is adapted to generate said test input ladder program based on said abnormal pattern.

7. The ladder program verification system of claim 5 wherein said ladder program includes a program formed in units of modules; said simulation air tool further comprising a module test sequence importing part for importing test input sequences created by said test input sequence managing part to a test input sequence of the whole of said ladder program.

8. The ladder program verification system of claim 6 wherein said ladder program includes a program formed in units of modules; said simulation air tool further comprising a module test sequence importing part for importing test input sequences created by said test input sequence managing part to a test input sequence of the whole of said ladder program.

9. The ladder program verification system of claim 5 wherein said simulation aid tool and said virtual I/O are network-connected to each other;
wherein said simulation aid tool is adapted to download the generated test input ladder program to said network-connected virtual I/O; and
wherein said virtual I/O is adapted to execute said download test input ladder program and to output said test input signal.

10. The ladder program verification system of claim 6 wherein said simulation aid tool and said virtual I/O are network-connected to each other;
wherein said simulation aid tool is adapted to download the generated test input ladder program to said network-connected virtual I/O; and
wherein said virtual I/O is adapted to execute said download test input ladder program and to output said test input signal.

11. The ladder program verification system of claim 7 wherein said simulation aid tool and said virtual I/O are network-connected to each other;
wherein said simulation aid tool is adapted to download the generated test input ladder program to said network-connected virtual I/O; and
wherein said virtual I/O is adapted to execute said download test input ladder program and to output said test input signal.

12. The ladder program verification system of claim 8 wherein said simulation aid tool and said virtual I/O are network-connected to each other;
wherein said simulation aid tool is adapted to download the generated test input ladder program to said network-connected virtual I/O; and
wherein said virtual I/O is adapted to execute said download test input ladder program and to output said test input signal.

13. A program product comprising:
a first program part for carrying out a first process of analyzing a test target ladder program and thereby extracting variables that are used in said ladder program, said variables including input variables;
a second program part for carrying out a second process of managing a test input sequence describing a table that correlates command, variable name and normal input value of each of said input variables in said extracted variables in the order of test input; and
a third program part for carrying out a third process of generating a test input ladder program according to said test input sequence.

14. A method of generating a test input ladder program, said method comprising:
a first step of obtaining input variables by analyzing a test target ladder program and analyzing and extracting variables that are used in said ladder program;
a second step of storing a test input sequence describing a table that correlates command, variable name and normal input value of each of said input variables in the order of test input; and
a third step of generating a test input ladder program according to said stored test input sequence.

15. The method of claim 14 wherein said first step includes the steps of storing said extracted variables by classing said extracted variables into input variables and output variables and storing said input variables in correlation with values that can be assumed as test input values, wherein said second step includes the steps of referencing said stored test input values and generating a test input data pattern including an abnormal pattern that has a value which is not a normal input value set as test input value of a specified one of said input variables in said test input sequence, and wherein said third step includes the step of generating said test input ladder program based on said abnormal pattern.

16. A method of verifying a ladder program, said method comprising the steps of:
providing a simulation aid tool including a variable extracting part for analyzing a ladder program to be tested and extracting variables used in said ladder program, said variables including input variables, a test input sequence managing part for managing a test input sequence describing a table that correlates command, variable name and normal input value of each of said input variables in said extracted variables in the order of test input, and a test input ladder generating part for generating a test input ladder program according to said test input sequence created by said test input sequence managing part;
connecting through a network a virtual I/O which is a programmable controller for generating virtual I/O having installed therein said test input ladder program generated by said simulation aid tool and a programmable controller for executing a test target program which is a ladder program to be tested;
obtaining test input signals by executing said test input ladder program by said virtual I/O;
providing said obtained test input signals sequentially through said network to said programmable controller for executing a test target program;
obtaining said test input signals with said programmable controller for executing a test target program and executing said test target ladder program based on said obtained test input signals.

17. The method of claim 16 wherein said simulation aid tool further comprises:
a variable managing part for storing said variables extracted by said variable extracting part by classifying into input variables and output variables and storing said input variables in correlation with values that can be assumed as test input values; and
a test input pattern managing part for referencing said test input values stored in said variable managing part and creating and managing a test input data pattern including an abnormal pattern having an abnormal value which is not a normal value set as a test input value of a specified input variable in said test input sequence;
wherein said test input ladder generating part is adapted to generate said test input ladder program based on said abnormal pattern.

18. The method of claim 16 wherein said ladder program includes a program formed in units of modules; said simulation air tool further comprising a module test sequence importing part for importing test input sequences created by said test input sequence managing part to a test input sequence of the whole of said ladder program.

19. The method of claim 17 wherein said ladder program includes a program formed in units of modules; said simulation air tool further comprising a module test sequence importing part for importing test input sequences created by said test input sequence managing part to a test input sequence of the whole of said ladder program.

20. The method of claim 16 further comprising the steps of:
connecting further to said network an action monitor for monitoring conditions and results of an action test of said programmable controller for executing a test target program; and
using said action monitor to monitor results of execution of said test target ladder program based on said test input signals obtained by said programmable controller for executing a test target program.

21. The method of claim 17 further comprising the steps of:
connecting further to said network an action monitor for monitoring conditions and results of an action test of said programmable controller for executing a test target program; and
using said action monitor to monitor results of execution of said test target ladder program based on said test input signals obtained by said programmable controller for executing a test target program.

22. The method of claim 18 further comprising the steps of:
connecting further to said network an action monitor for monitoring conditions and results of an action test of said programmable controller for executing a test target program; and
using said action monitor to monitor results of execution of said test target ladder program based on said test input signals obtained by said programmable controller for executing a test target program.

23. The method of claim 19 further comprising the steps of:
connecting further to said network an action monitor for monitoring conditions and results of an action test of said programmable controller for executing a test target program; and
using said action monitor to monitor results of execution of said test target ladder program based on said test input signals obtained by said programmable controller for executing a test target program.
